(19) United States
(12) Patent Application Publication
(10) Pub. No.: US 2013/0051082 A1
(43) Pub. Date: Feb. 28, 2013

(54) SWITCHING POWER SUPPLY

(71) Applicants: Bu Won Lee, Gyunggi-do (KR); Won Jin Cho, Gyunggi-do (KR); Kyu Bum Han, Gyunggi-do (KR)

(72) Inventors: Bu Won Lee, Gyunggi-do (KR); Won Jin Cho, Gyunggi-do (KR); Kyu Bum Han, Gyunggi-do (KR)

(73) Assignee: SAMSUNG ELECTRO-MECHANICS CO., LTD., Gyunggi-do (KR)

(21) Appl. No.: 13/474,073

(22) Filed: May 17, 2012

(30) Foreign Application Priority Data
Aug. 25, 2011 (KR) 1020110085318

(51) Int. Cl. H02M 3/335

(52) U.S. Cl. 363/17

(57) ABSTRACT

Disclosed herein is a switching power supply including: N sub switching power supplying unit each converting a direct current (DC) power supplied from a power source into an alternate current (AC) power, boosting or bucking the AC power using a resonant circuit and a contactless transformer, converting the boosted or bucked AC power into a DC power, and outputting the converted DC power; and a balance circuit connecting between the resonant circuits of the N sub switching power supplying units to thereby allow currents to be balanced between the resonant circuits.

### CROSS REFERENCE TO RELATED APPLICATION

This application claims the benefit of Korean Patent Application No. 10-2011-0085318, filed on Aug. 25, 2011, entitled “Switched Power Supply”, which is hereby incorporated by reference in its entirety into this application.

### BACKGROUND OF THE INVENTION

1. Technical Field

The present invention relates to a switching power supply.

2. Description of the Related Art

In recent years, in accordance with the development of a switching element capable of withstanding a relatively large high frequency current and voltage, a switching mode power supply has been mainly used as a power supply obtaining a desired direct current (DC) voltage by rectifying commercial power.

The switching mode power supply, which has a high switching frequency, allows a transformer and other device to have a small size, is a high power DC-DC converter, and is used as a power supply for various electronic devices.

Meanwhile, in accordance with the recent increase in power demand, an output power of the switching power supply has gradually increased.

In this situation, since the switching power supply converts a DC power into an alternate current (AC) power by switching the DC power and then performs rectification and planarization to obtain an output power, the increase in output power causes an increase in noise.

As one of methods capable of avoiding or suppressing the generation of noise, a method using current resonant circuits in a power transmitting unit of a power supply is used.

However, when the current resonant circuits are connected in parallel with each other in the power supply using the current resonant circuits, a current is concentrated in any resonant circuit due to deviation between circuit parameters.

As an example of the technology according to the prior art for solving this problem, there is Japanese Patent Laid-Open Publication No. 2005-033938. In this patent, unbalance in current is solved by adjusting main trans-leakage inductances of power.

However, in this patent, the leakage inductance values are specifically read and the liquid inductances of the power are individually adjusted. Therefore, a process is complicated, such that implementation is not easy.

As another example, there is Japanese Patent Laid-Open Publication No. 2001-008452. In this patent, the unbalance in current is solved by controlling a peak value of a current flowing in a resonant inductance.

However, in this patent, frequencies operating each resonant circuit are changed, such that an unusual ripple voltage is generated in an output.

### SUMMARY OF THE INVENTION

The present invention has been made in an effort to provide a switching power supply capable of preventing concentration of a current in any resonant circuit due to deviation between circuit parameters by including a balance circuit added when resonant circuits are connected in parallel with each other.

According to a preferred embodiment of the present invention, there is provided a switching power supply including: N sub switching power supplying units each converting a direct current (DC) power supplied from a power source into an alternate current (AC) power, boosting or bucking the AC power using a resonant circuit and a contactless transformer, converting the boosted or bucked AC power into a DC power, and outputting the converted DC power; and a balance circuit connecting between the resonant circuits of the N sub switching power supplying units to thereby allow currents to be balanced between the resonant circuits.

The sub switching power supplying unit may include: a DC-AC converter converting the DC power supplied from the power source into the AC power; an AC-DC converter converting the boosted or bucked AC power output from the contactless transformer into the DC power and outputting the converted DC power; the contactless transformer boosting or bucking the AC power output from the DC-AC converter and outputting the boosted or bucked AC power output to the AC-DC converter; and the resonant circuit disposed between the DC-AC converter and the contactless transformer to thereby allow a maximum power to be transmitted from a primary winding of the contactless transformer to a secondary winding thereof.

The DC-AC converter may be a full bridge converter in which four switching elements are configured in a full bridge scheme.

The DC-AC converter may be a half bridge converter in which two switching elements are configured in a half bridge scheme.

The AC-DC converter may be a full bridge rectifier circuit in which four diode elements are configured in a full bridge scheme.

The AC-DC converter may be a half bridge rectifier circuit in which two diode elements are configured in a half bridge scheme.

Output terminals of the AC-DC converters of each of the N sub switching power supplying units may be connected in parallel with each other.

Output terminals of the AC-DC converters of each of the N sub switching power to supplying units may be connected in series with each other.

The balance circuit may include N−1 capacitors for balance connecting between the resonant circuits of the sub switching power supplying units that are adjacent to each other to thereby allow the currents to be balanced between the resonant circuits.

The balance circuit may further include a capacitor for balance connecting between the resonant circuits of the sub switching power supplying units that are not adjacent to each other to thereby allow the currents to be balanced between the resonant circuits.

The resonant circuit may include a resonant capacitor and a resonant inductor that are connected in series with each other, and the balance circuit may include N−1 capacitors for balance each having one terminal connected between a resonant capacitor and a resonant inductor of a resonant circuit configuring any one sub switching power supplying unit and the other terminal connected between a resonant capacitor and a resonant inductor of a resonant circuit configuring another sub switching power supplying unit that is adjacent to any one sub switching power supplying unit to thereby allow the currents to be balanced between the resonant circuits of the N sub switching power supplying units.

The balance circuit may further include a capacitor for balance having one terminal connected between a resonant capacitor and a resonant inductor of a resonant circuit configuring any one sub switching power supplying unit and the other terminal connected between a resonant capacitor and a resonant inductor of a resonant circuit configuring another sub switching power supplying unit that is not adjacent to any one sub switching power supplying unit to thereby allow the currents to be balanced between the resonant circuits of the N sub switching power supplying units.

### BRIEF DESCRIPTION OF THE DRAWINGS

FIG. 1 is a configuration diagram of a switching power supply according to a first preferred embodiment of the present invention;

FIG. 2 is a diagram showing a direct current (DC)-alternate current (AC) converter of FIG. 1 according to another preferred embodiment of the present invention;

FIG. 3 is a waveform diagram in a case in which first and second resonant circuits are separated from each other;

FIG. 4 is a waveform diagram in a case in which first and second resonant circuits are connected to each other by a balance circuit;

FIG. 5 is a waveform diagram showing a current flowing in a balance circuit;

FIG. 6 is a diagram showing an AC-DC converter according to still another preferred embodiment of the present invention;

FIG. 7 is a configuration diagram of a switching power supply according to a second preferred embodiment of the present invention; and

FIG. 8 is a configuration diagram of a switching power supply according to a third preferred embodiment of the present invention.

### DESCRIPTION OF THE PREFERRED EMBODIMENTS

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

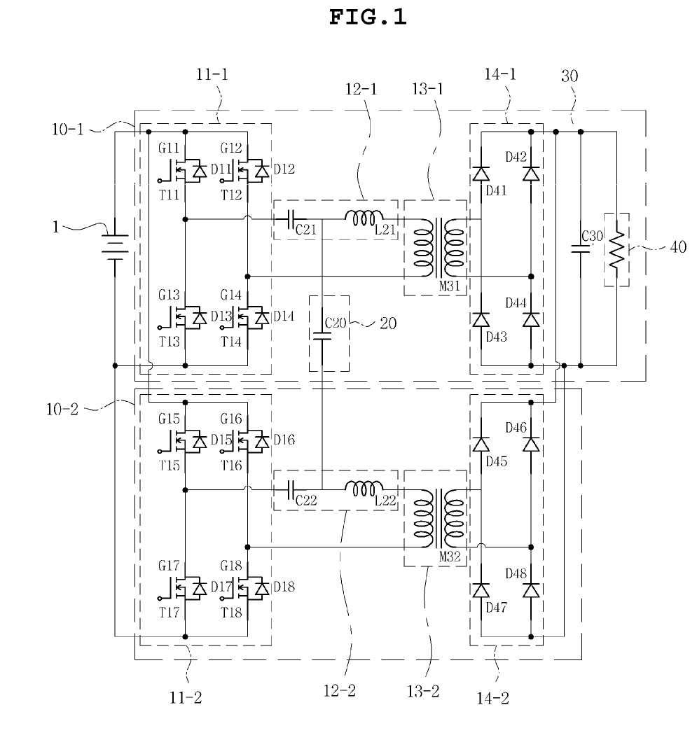

FIG. 1 is a configuration diagram of a switching power supply according to a first preferred embodiment of the present invention.

Referring to FIG. 1, a switching power supply according to a first preferred embodiment of the present invention is configured to include two sub switching power supplying units 10-1 and 10-2, a balance circuit 20, and a filter unit 30.

The first sub switching power supplying unit 10-1 includes a first direct current (DC)-alternate current (AC) converter 11-1, a first resonant circuit 12-1, a first contactless transformer 13-1, and a first AC-DC converter 14-1, and the second sub switching power supplying unit 10-2 includes a second direct current (DC)-alternate current (AC) converter 11-2, a second resonant circuit 12-2, a second contactless transformer 13-2, and a second AC-DC converter 14-2.

In this configuration, the first DC-AC converter 11-1 includes a pair of MOSFETs, that is, first and second MOSFETs T11 and T12 each having a drain connected to one terminal of an output side of a power source 1 and a source connected to each of two terminals of the first contactless transformer 13-1 and a pair of MOSFETs, that is, third and fourth MOSFETs T13 and T14 each having a drain connected to each of two terminals of the first contactless transformer 13-1 and a source connected to the other terminal of the power source 1.

In addition, the first DC-AC converter 11-1 includes four reverse parallel diodes, that is, first to fourth reverse parallel diodes D11, D12, D13, and D14 each connected between the drains and the sources of the respective first to fourth MOSFETs T11, T12, T13, and T14 in a reverse direction in order to prevent backward flow of a current from a secondary winding of the first contactless transformer 13-1.

The DC-AC converter 11-1 configured as described above provides an AC current to the secondary winding of the first contactless transformer 13-1 by switching gate terminals G11, G12, G13, and G14 of four MOSFETs.

Next, the second DC-AC converter 11-2 includes a pair of MOSFETs, that is, fifth and sixth MOSFETs T15 and T16 each having a drain connected to one terminal of the output side of the power source 1 and a source connected to each of two terminals of the second contactless transformer 13-2 and a pair of MOSFETs, that is, seventh and eighth MOSFETs T17 and T18 each having a drain connected to each of two terminals of the second contactless transformer 13-2 and a source connected to the other terminal of the power source 1.

In addition, the second DC-AC converter 11-2 includes four reverse parallel diodes, that is, fifth to eighth reverse parallel diodes D15, D16, D17, and D18 each connected between the drains and the sources of the respective fifth to eighth MOSFETs T15, T16, T17, and T18 in a reverse direction in order to prevent backward flow of a current from a secondary winding of the second contactless transformer 13-2.

The DC-AC converter 11-2 configured as described above provides an AC current to the secondary winding of the second contactless transformer 13-2 by switching gate terminals G15, G16, G17, and G18 of four MOSFETs.

Although the first DC-AC converter 11-1 or the second DC-AC converter 11-2 as described above uses the MOSFET as a switching element, the present invention is not limited. For example, the first DC-AC converter 11-1 or the second DC-AC converter 11-2 may also use other kinds of FETs or BJTs as the switching element.

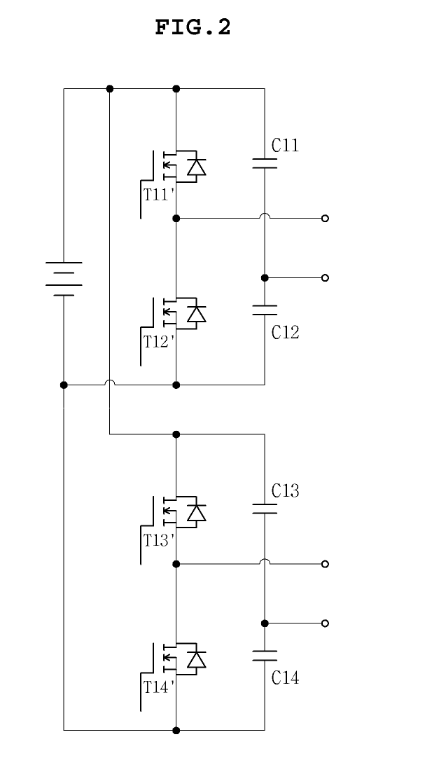

In addition, although the first DC-AC converter 11-1 is implemented as a full bridge circuit using four switching elements, the present invention is not limited thereto. For example, the first DC-AC converter 11-1 may be implemented as a half bridge circuit using two MOSFETs T11′ and T12′ and two capacitor C11 and C12 as shown in FIG. 2, and the second DC-AC converter 11-2 may also be implemented as a half bridge circuit using two MOSFETs T13′ and T14′ and two capacitor C13 and C14 as shown in FIG. 2.

In this configuration, each terminal of the first and second contactless transformers 13-1 and 13-2 is connected between a pair of MOSFETs and a pair of capacitors.

Meanwhile, the first resonant circuit 12-1 has a structure in which a resonant capacitor C21 and a resonant inductor L21 are connected in series with each other, and is connected in series between the first DC-AC converter 11-1 and the first contactless transformer 13-1 to thereby allow the maximum power to be transmitted according to the selection of appropriate element values. Here, the resonant capacitor C21 and the resonant inductor L21 configuring the first resonant circuit 12-1 may be disposed at relatively changed positions as long as they may be connected in series with each other, and may be installed at any position as long as they are positioned only between the first DC-AC converter 11-1 and the first contactless transformer 13-1.

Next, the second resonant circuit 12-2 has a structure in which a resonant capacitor C22 and a resonant inductor L22 are connected in series with each other, and is connected in series between the second DC-AC converter 11-2 and the second contactless transformer 13-2 to thereby allow the maximum power to be transmitted according to the selection of appropriate element values. Here, the resonant capacitor C22 and the resonant inductor L22 configuring the second resonant circuit 12-2 may be disposed at relatively changed positions as long as they may be connected in series with each other, and may be installed at any position as long as they are positioned only between the second DC-AC converter 11-2 and the second contactless transformer 13-2.

Next, the first contactless transformer 13-1 has a primary winding connected to the first DC-AC converter 11-1 and the secondary winding connected to the first AC-DC converter 14-1.

The first contactless converter 13-1 boosts or bucks a voltage and a current applied to the primary winding according to a turn ratio and transfers the boosted or bucked voltage and current to the secondary winding to thereby allow a constant current to be applied to the first AC-DC converter 14-1.

Here, the first resonant circuit 12-1 configured of the resonant capacitor C21 and the resonant inductor L21 is connected in series with the primary winding of the first contactless transformer 13-1, such that the first contactless transformer 13-1 may transmit the maximum power according to the selection of appropriate element values of the first resonant circuit 12-1.

In addition, the second contactless transformer 13-2 has a primary winding connected to the second DC-AC converter 11-2 and the secondary winding connected to the second AC-DC converter 14-2.

The second contactless transformer 13-2 boosts or bucks a voltage and a current applied to the primary winding according to a turn ratio and transfers the boosted or bucked voltage and current to the secondary winding to thereby allow a constant current to be applied to the second AC-DC converter 14-2.

Here, the second resonant circuit 12-2 configured of the resonant capacitor C22 and the resonant inductor L22 is connected in series with the primary winding of the second contactless transformer 13-2 to thereby allow the maximum power to be transmitted according to the selection of appropriate element values of the second resonant circuit 12-2.

Meanwhile, the balance circuit 20 is inserted between the first resonant circuit 12-1 and the second resonant circuit 12-2 to thereby allow currents of the first and second resonant circuits 12-1 and 12-2 to be balanced. This balance circuit 20 may be implemented as a capacitor C20 for balance. The capacitor C20 for balance has one terminal connected to the first resonant circuit 12-1 (more specifically, connected between the first capacitor C21 and the first inductor L21) and the other terminal connected to the second resonant circuit 12-2 (more specifically, connected between the second capacitor C22 and the second inductor L22) to thereby allow the currents of the first and second resonant circuits 12-1 and 12-2 to be balanced.

The balance circuit 20 performs a similar or same function as a function of short-circuiting the first and second resonant circuits 12-1 and 12-2, such that a current waveform (or a voltage waveform) of the first resonant circuit 12-1 and a current waveform (or a voltage waveform) of the second resonant circuit 12-2 become similar or identical to each other.

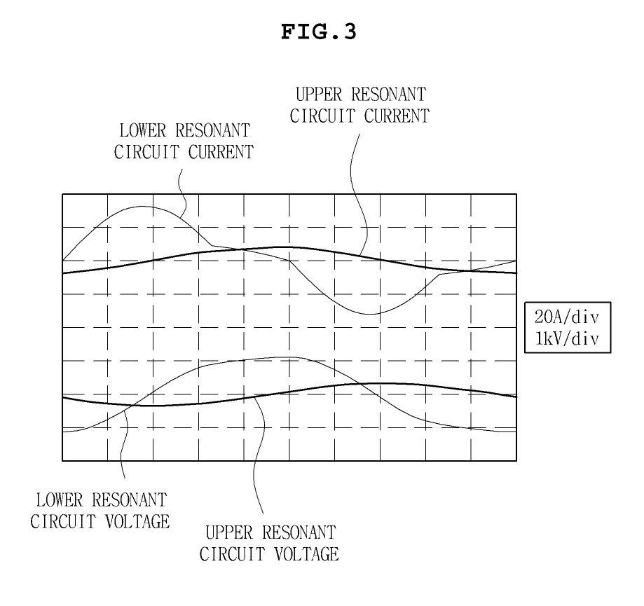

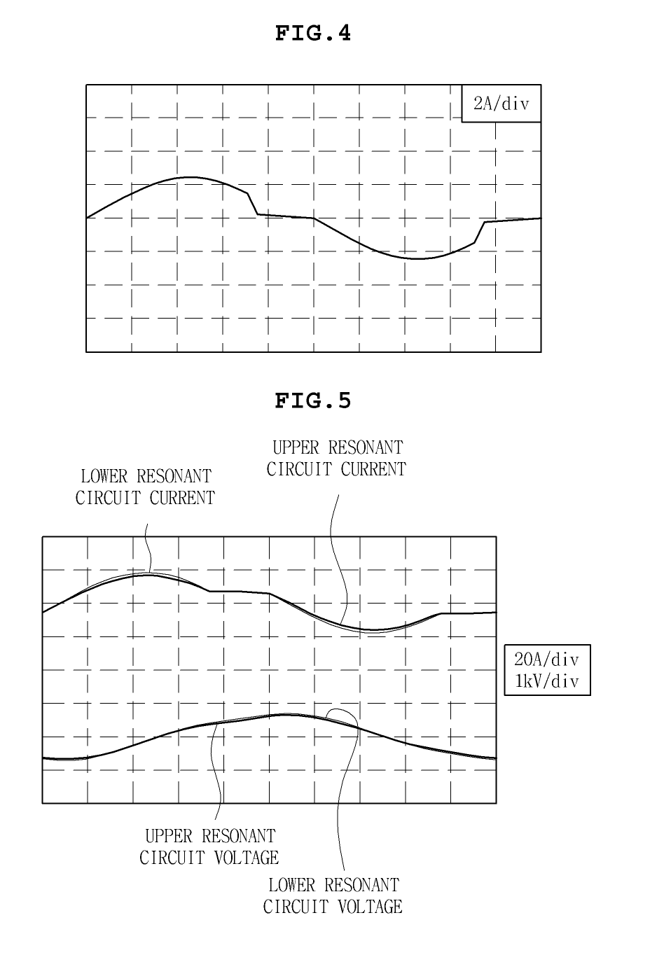

When FIG. 3 showing a waveform in a case in which the first and second resonant circuits 12-1 and 12-2 are separated from each other and FIG. 4 showing a waveform in a case in which the first and second resonant circuits 12-1 and 12-2 are connected to each other by the balance circuit 20 are compared with each other, a role of the balance circuit 20 may be easily understood.

It may be appreciated from FIG. 3 showing a waveform in a case in which the first and second resonant circuits 12-1 and 12-2 are separated from each other that a current (or a voltage) of the first resonant circuit 12-1 is different from a current (or a voltage) of the second resonant circuit 12-2.

Unlike this, it may be appreciated from FIG. 4 showing a waveform in a case in which the first and second resonant circuits 12-1 and 12-2 are connected to each other by the balance circuit 20 that a current (or a voltage) of the first resonant circuit 12-1 coincides with a current (or a voltage) of the second resonant circuit 12-2.

Here, it may be appreciated from a waveform diagram of a current shown in FIG. 5 that a current flowing in the balance circuit 20 is smaller than currents flowing in the first and second resonant circuits 12-1 and 12-2.

According to the prior art, a difference generated in a current (or a voltage) between the first and second resonant circuits 12-1 and 12-2 is due to a difference in impedance therebetween.

This difference in impedance is generated since the first and second resonant circuits 12-1 and 12-2 are separated from each other. Therefore, a current flow is unbalanced.

However, according to the preferred embodiment of the present invention, the first and second resonant circuits 12-1 and 12-2 are connected to each other by the balance circuit 20, such that each of the first and second resonant circuits 12-1 and 12-2 may not be independently operated.

In addition, the balance circuit 20 distributes impedances to both of the resonant circuits 12-1 and 12-2 so that a difference in impedance is solved, thereby allowing the impedances to coincide with each other. Therefore, the unbalance in impedance is solved, such that the current (or voltage) waveforms coincide with each other.

When the current (or voltage) waveforms of the first and second resonant circuits 12-1 and 12-2 become similar or identical to each other by the balance circuit 20 as described above, a waveform of a current (or a voltage) induced in the first AC-DC converter 14-1 by the first contactless transformer 13-1 becomes similar or identical to that of a current (or a voltage) induced in the second AC-DC converter 14-2 by the second contactless transformer 13-2.

When the currents (or the voltages) generated in the first and second AC-DC converters 14-1 and 14-2 are similar or identical to each other as described above, a load 40 may receive power uniformly distributed from the first and second AC-DC converters 14-1 and 14-2, thereby making it possible to prevent a phenomenon in which a load for supplying a power is weighted on any one of the first and second AC-DC converters 14-1 and 14-2.

Meanwhile, the first AC-DC converter 14-1 is formed of a full-wave bridge rectifier circuit in which four diodes D41, D42, D43, and D44 are connected to each other in a bridge scheme. In this configuration, when a positive current is applied to a first terminal a of the bridge circuit, the first and fourth diodes D41 and D44 are turned on, such that the current passes therethough, and when a negative current is applied to a second terminal b thereof, the second and third diodes D42 and D43 are turned on, such that the current passes therethrough.

Therefore, when a load is connected between output terminals of the bridge rectifier circuit of the first AC-DC converter 14-1, the current passing through the bridge rectifier circuit constantly flows in the load.

Next, the second AC-DC converter 14-2 is formed of a full-wave bridge rectifier circuit in which four diodes D45, D46, D47, and D48 are connected to each other in a bridge scheme. In this configuration, when a positive current is applied to a first terminal c of the bridge circuit, the first and fourth diodes D45 and D48 are turned on, such that the current passes therethough, and when a negative current is applied to a second terminal d thereof, the second and third diodes D46 and D47 are turned on, such that the current passes therethrough.

Therefore, when a load is connected between both terminals of the bridge rectifier circuit of the second AC-DC converter 14-2, the current passing through the bridge rectifier circuit constantly flows in the load.

Meanwhile, the first and second AC-DC converters 14-1 and 14-2 are connected in parallel with each other and uniformly share the powers supplied to the load 40.

Unlike this, the first and second AC-DC converters 14-1 and 14-2 may be implemented so as to be connected in series with each other.

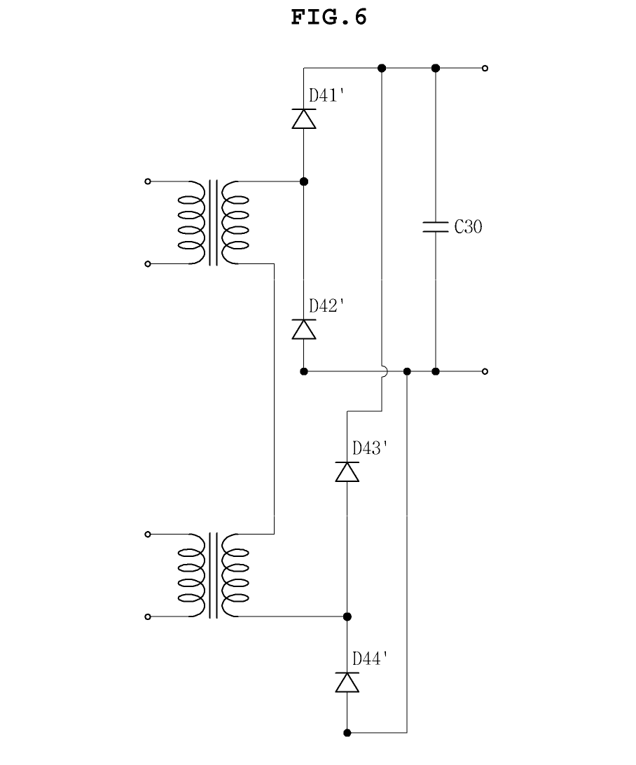

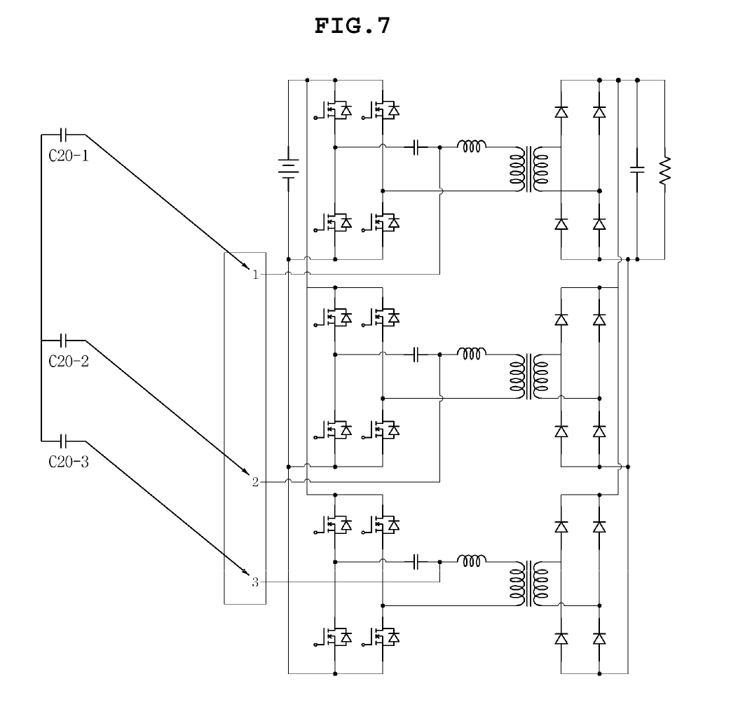

In this case, the first AD-DC converter 14-1 does not use a full bridge rectifier circuit implemented by four diodes but uses a half bridge rectifier circuit implemented by two diodes D41′ and D42′ as shown in FIG. 6, and the second AD-DC converter 14-2 does not also use a full bridge rectifier circuit implemented by four diodes but uses a half bridge rectifier circuit implemented by two diodes D43′ and D44′ as shown in FIG. 6 and connects output terminals of the half bridge rectifier circuits to each other, thereby making it possible to connect the first and second AD-DC converters in series with each other.

Next, the filter unit 30 includes a capacitor C30 connected in parallel between the both terminals of the first and second AC-DC converters 14-1 and 14-2.

This capacitor C30 configures a band pass filter to pass a DC power output from the AC-DC converters 14-1 and 14-2 therethrough while removing noise and interference of unnecessary high frequency signals in the DC power.

Meanwhile, although the case in which the switching power supply is configured of two sub switching power supplying units has been described, the switching power supply may be configured of a plurality of sub switching power supplying units.

In this case, the number of balance circuits connecting between resonant circuits of the plurality of sub switching power supplying units is plural, and the connection is made in a Y shape in which the plurality of balance capacitors C20-1, C20-2, and C20-3 are connected between the resonant circuits, that is, one capacitor is connected between the resonant circuits, as shown in FIG. 7.

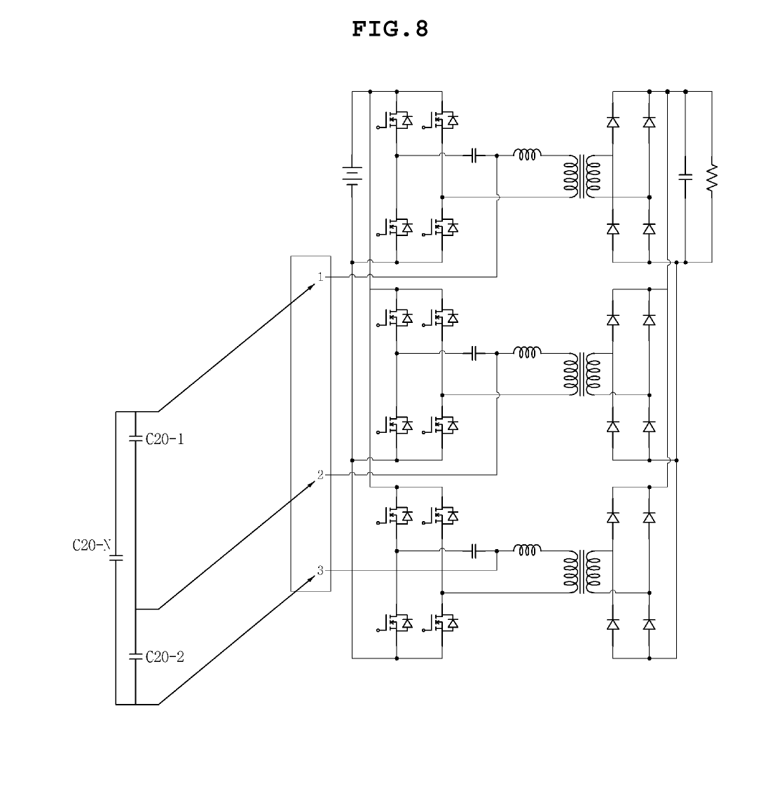

In addition, as another example, the connection may be made in a Δ shape in which each of the plurality of balance capacitors C20-1 and C20-2 is connected between the resonant circuits and a separate balance capacitor C20-N is additionally connected between a resonant circuit of a first sub switching power supplying unit and a resonant circuit of a final sub switching power supplying unit, as shown in FIG. 8.

As described above, according to the preferred embodiment of the present invention, the balance circuit is added to allow the impedances between the resonant circuits to coincide with each other, thereby making it possible to allow the currents to be balanced.

In addition, according to the preferred embodiment of the present invention, the currents flowing in the resonant circuits coincide with each other, thereby making it possible to prevent the current from being concentrated in any resonant circuit.

Further, according to the preferred embodiment of the present invention, the currents are balanced between the resonant circuits, thereby making it possible to obtain a large output power in the switching power supply.

Furthermore, in this case, the current flowing in the balance circuit is relatively lower than the current flowing in the resonant circuit, thereby making it possible to adjust the current balance of the resonant circuits without reducing efficiency.

Although the preferred embodiments of the present invention have been disclosed for illustrative purposes, they are for specifically explaining the present invention. Therefore, a switching power supply according to the preferred embodiments of the present invention is not limited thereto, but those skilled in the art will appreciate that to various modifications and alteration are possible, without departing from the scope and spirit of the invention as disclosed in the accompanying claims. Accordingly, such modifications and alterations should also be understood to fall within the scope of the present invention. A specific protective scope of the present invention could be defined by the accompanying claims.

What is claimed is:

1. A switching power supply comprising:
N sub switching power supplying units each converting a direct current (DC) power supplied from a power source into an alternate current (AC) power, boosting or bucking the AC power using a resonant circuit and a contactless transformer, converting the boosted or bucked AC power into a DC power, and outputting the converted DC power; and
a balance circuit connecting between the resonant circuits of the N sub switching power supplying units to thereby allow currents to be balanced between the resonant circuits.

2. The switching power supply as set forth in claim 1, wherein the sub switching power supplying unit includes:
a DC-AC converter converting the DC power supplied from the power source into the AC power;
an AC-DC converter converting the boosted or bucked AC power output from the contactless transformer into the DC power and outputting the converted DC power;
the contactless transformer boosting or bucking the AC power output from the DC-AC converter and outputting the boosted or bucked AC power output to the AC-DC converter; and
the resonant circuit disposed between the DC-AC converter and the contactless transformer to thereby allow a maximum power to be transmitted from a primary winding of the contactless transformer to a secondary winding thereof.

3. The switching power supply as set forth in claim 2, wherein the DC-AC converter is a full bridge converter in which four switching elements are configured in a full bridge scheme.

4. The switching power supply as set forth in claim 2, wherein the DC-AC converter is a half bridge converter in which two switching elements are configured in a half bridge scheme.

5. The switching power supply as set forth in claim 2, wherein the AC-DC converter is a full bridge rectifier circuit in which four diode elements are configured in a full bridge scheme.

6. The switching power supply as set forth in claim 2, wherein the AC-DC converter is a half bridge rectifier circuit in which two diode elements are configured in a half bridge scheme.

7. The switching power supply as set forth in claim 2, wherein output terminals of the AC-DC converters of each of the N sub switching power supplying units are connected in parallel with each other.

8. The switching power supply as set forth in claim 2, wherein output terminals of the AC-DC converters of each of the N sub switching power supplying units are connected in series with each other.

9. The switching power supply as set forth in claim 1, wherein the balance circuit includes N−1 capacitors for balance connecting between the resonant circuits of the sub switching power supplying units that are adjacent to each other to thereby allow the currents to be balanced between the resonant circuits.

10. The switching power supply as set forth in claim 9, wherein the balance circuit further includes a capacitor for balance connecting between the resonant circuits of the sub switching power supplying units that are not adjacent to each other to thereby allow the currents to be balanced between the resonant circuits.

11. The switching power supply as set forth in claim 1, wherein the resonant circuit includes a resonant capacitor and a resonant inductor that are connected in series with each other, and
the balance circuit includes N−1 capacitors for balance each having one terminal connected between a resonant capacitor and a resonant inductor of a resonant circuit configuring any one sub switching power supplying unit and the other terminal connected between a resonant capacitor and a resonant inductor of a resonant circuit configuring another sub switching power supplying unit that is adjacent to any one sub switching power supplying unit to thereby allow the currents to be balanced between the resonant circuits of the N sub switching power supplying units.

12. The switching power supply as set forth in claim 11, wherein the balance circuit further includes a capacitor for balance having one terminal connected between a resonant capacitor and a resonant inductor of a resonant circuit configuring any one sub switching power supplying unit and the other terminal connected between a resonant capacitor and a resonant inductor of a resonant circuit configuring another sub switching power supplying unit that is not adjacent to any one sub switching power supplying unit to thereby allow the currents to be balanced between the resonant circuits of the N sub switching power supplying units.
